(19) United States
(12) Patent Application Publication
(10) Pub. No.: US 2014/0072505 A1
(43) Pub. Date: Mar. 13, 2014

(54) Layered multiphase catalyst supports and carbon nanotubes produced thereon

(71) Applicants: Antonio Fonseca, Louvain-la-Neuve (BE); Danilo Vuono, Castrolibero (IT); Janos B.Nagy, Jambes (BE)

(72) Inventors: Antonio Fonseca, Louvain-la-Neuve (BE); Danilo Vuono, Castrolibero (IT); Janos B.Nagy, Jambes (BE)

(21) Appl. No.: 13/606,411

(22) Filed: Sep. 7, 2012

(51) Int. Cl. D01F 9/12; B01J 35/02; B82Y 30/00

(52) U.S. Cl. 423/447.2; 502/100; 977/742; 977/750; 977/752

(57) ABSTRACT

The present invention is related to layered multiphase catalyst supports and to their use for production of helical carbon nanotubes. The metal(s) catalysts are deposited either by impregnation or by precipitation.

### FIELD OF THE INVENTION

The present invention is related to the field of layered multiphase supported catalysts for carbon nanotubes production. More precisely, the present invention is related to layered multiphase supported catalysts, made of layered multiphase particles containing catalysts (nanoparticles), for helical carbon nanotubes production.

### STATE OF THE ART

Carbon nanotubes were first identified by Iijima in 1991 (S. Iijima, Nature 354 (1991) 56-58), but they were already observed by Oberlin in 1976 (A. Oberlin et al., J. Crystal Growth 32 (1976) 335-349).

Carbon nanotubes can be produced by laser ablation, by arc discharge or by catalytic carbon vapor deposition (CCVD).

The production of carbon nanotubes by the CCVD technique, applying supported catalysts, was developed to produce both multi-wall nanotubes (MWNTs) and single-wall nanotubes (SWNTs), depending on the catalyst support and active metals (N. Nagaraju et al., Patent application WO 03/004410). In that work, the authors applied several catalyst preparation techniques to obtain homogeneous catalyst powders. Nevertheless, none of the catalysts described was reported to be active and selective towards helical nanotubes production.

Zeolites, Al₂O₃ and MgO supported transition metals are very interesting systems for large-scale synthesis of carbon nanotubes. Indeed, the catalytic decomposition of ethylene at high temperature leads to the formation of thick, thin or very thin multi-wall carbon nanotubes (MWNTs) depending on the catalyst support and active metals. The decomposition of ethylene on NaY zeolite or Al₂O₃ favors, respectively the growth of thick (av. inner/outer diameters 6/25 nm) or thin (av. inner/outer diameters 4/15 nm) MWNTs, while the use of MgO leads to the formation of very thin (av. inner/outer diameters 4/10 nm) MWNTs. The decomposition of methane, on the other hand, produces bundles and isolated single-wall nanotubes (SWNTs). Typically, the diameters of isolated SWNTs are 1-4 nm, and the average diameter is 2 nm. DWNTs of 3-4 nm outer diameters are also present in the samples.

The production of helical carbon nanotubes, first produced by the group of Prof. Janos B. NAGY at FUNDP (S. Amelinckx et al., Science 265 (1994) 635-639), was further developed, aiming at obtaining samples containing large proportions of helical nanotubes among the straight and coiled tubes. Nevertheless, none of the process for obtaining helical nanotubes is sufficiently selective and, actually the best selectivity reached is in the order of 10% of helical nanotubes in the samples. Moreover, the pitch and diameter of the helices are not yet controlled and researches are still needed to increase the selectivity.

The invention discloses the preparation of layered multiphase catalyst supports containing catalysts that are more active and more selective, towards helical nanotubes production, than other supported catalysts prepared applying other techniques. As a result of the high activity and high selectivity of the catalysts described in the present invention, crude CNTs of high helical nanotubes content (10%<content<95%) can be produced. The higher helical nanotubes content of the latter crude helical CNTs makes them suitable for many CNTs applications.

According to A. R. Barron et al. [Advanced Materials & Process 166, Issue 10 (2008) 41-43], the potential CNTs market is substantial and the nanotubes global market is supposed to raise 1.2 B [symbol] in 2010. In fact, even though the demand is bigger for composites reinforcement compared to ESD (Electrostatic Discharge) applications, nanotubes are already sold in hundreds of tons scale, per year, for the ESD application but very few for composites reinforcement because of the lack of appropriate nanotubes. In fact, because of pull out problems, linear CNTs are too small to be used at unit level, for composites reinforcement, in macroscopic materials. However, due to their helical configuration, helical nanotubes are ideal reinforcement for composites and polymer-based materials, as they cannot so easily be pulled out from the matrix. Hence, helical nanotubes have a great potential to be used for composite materials.

### PRELIMINARY DEFINITIONS

It is meant by “multiphase catalyst support” any multi (double, triple . . . ) combination of catalyst supports such as silica/zeolite, silica/alumina, silica/silica, silica/clay, alumina/silica, alumina/zeolite, alumina/clay, am. carbon/silica, am. carbon/zeolite, am. carbon/clay, am. carbon/alumina, alumina/silica/zeolite . . .

It is meant by “layered multiphase supported catalyst” a material made of layered multiphase particles containing catalyst nanoparticles.

The “catalyst” comprises generally metal, metal-oxides or other metal derivatives or mixtures thereof.

The term “metal(s)” stands for a single metal (i.e., Co, Fe, Pr, V, Mo, Sn, Ni, Cu, Zn, Cr, . . . ) or a mixture of two or more metals. The total metal(s) loading of the layered multiphase supported catalyst preferably varies from 0.1 to 10 wt % and more preferably from 1 to 5 wt %.

The terms “metalorganic” or “metalinorganic” stand for metal salts the anion(s) of which are organic or inorganic ions, respectively.

The expression “active catalyst” refers to any metal, metal-oxide or other metal-derivatives formed during the initial heating of the layered multiphase supported catalyst by the reaction between the layered multiphase support, the catalyst and the gases. The active catalyst is responsible for the carbon nanotubes production by CCVD.

“CCVD” is the English abbreviation for Catalytic Carbon Vapor Deposition and refers to a catalytic decomposition of hydrocarbons.

The “hydrocarbon” can be acetylene, ethylene, butane, propane, ethane, methane or any other gaseous or volatile carbon containing compound. Of particular interest are the hydrocarbons containing nitrogen (i.e. acetonitrile, . . . ), favoring the introduction of nitrogen in the body of the CNTs. The “hydrocarbon” can also be a mixture of hydrocarbons.

The terms CNTs, MWNTs, DWNTs and SWNTs stand for carbon nanotubes, multi-wall carbon nanotubes, double-wall carbon nanotubes and single-wall carbon nanotubes, respectively. The term CNTs is used to represent MWNTs+DWNTs+SWNTs, in any proportion. DWNTs are part of the MWNTs.

The term “hCNTs” stands for helical CNTs. Helical CNTs are nanotubes the bodies of which are shaped like a cork-screw. hCNTs are characterized by the three parameters D, P and d that are the coil diameter, the coil pitch and the nanotube diameter, respectively (A. Fonseca et al., Carbon, 33 (1995) 1759-1774).

The expression “Crude nanotubes” refers to a mixture of carbon nanotubes and spent supported catalyst.

The “carbon material” is made of SWNTs, MWNTs, carbon fibers, carbon nanoparticles, amorphous carbon, pyrolytic carbon and soot in variable weight ratios.

The expression “monodisperse in diameter” means diameter in narrow distribution.

The abbreviations AcO, acac and C₂O₂ stand for acetate, acetylacetonate and oxalate, respectively.

### AIMS OF THE INVENTION

The present invention aims to provide layered multiphase supported catalysts for carbon helical nanotubes production by CCVD. Furthermore, the present invention presents the production of crude CNTs of high helical nanotubes content (10%<content<95%).

### SUMMARY OF THE INVENTION

The present invention is related to layered multiphase supported catalysts and to their use for production of helical carbon nanotubes. The metal(s) catalysts are deposited either by impregnation or by precipitation.

### SHORT DESCRIPTION OF THE DRAWINGS

FIG. 1: Schematic representation of the layered multiphase supported catalysts of the present invention. Each internal circle represents the interface of two support phases and the outer circle represents the limit of the outer phase. The black dots represent the catalyst nanoparticles. Mainly double layer (I, II, III) and triple layer (I′, II′, III′, IV) multiphase supported catalysts are represented but these catalysts can be further coated (i.e. IV′), hence increasing the number of layers. The different types of layered multiphase supported catalysts of the present invention (FIG. 1) can be produced, for instance, by the processes described hereafter:
Type I: Processes G(Xc), H, H′, H″, H″′, H^{IV}, I, I′, I″, I″′, J′, J″
Type II: Processes K′, K″
Type III: Process G(X)
Type IV: Process O
Type I′: Process L
Type II′: Process M
Type III′: Process N
Type IV′: Process P
Type V (not illustrated in FIG. 1): Process Q

FIG. 2: Schematic representation of the layered multiphase supported catalysts naming. In the catalyst name, si, al and ze stand for silica gel (i.e. silica 60), alumina (i.e. gamma alumina) and zeolite (i.e. NaY zeolite), respectively; Al, Si and Am stand for amorphous alumina (i.e. Al(OH)₃), amorphous silica (i.e. fumed silica) and amorphous carbon (i.e. Norit A), respectively. To the core and to each of the coatings, indices can be added to specify the sub-process used, if several are possible.

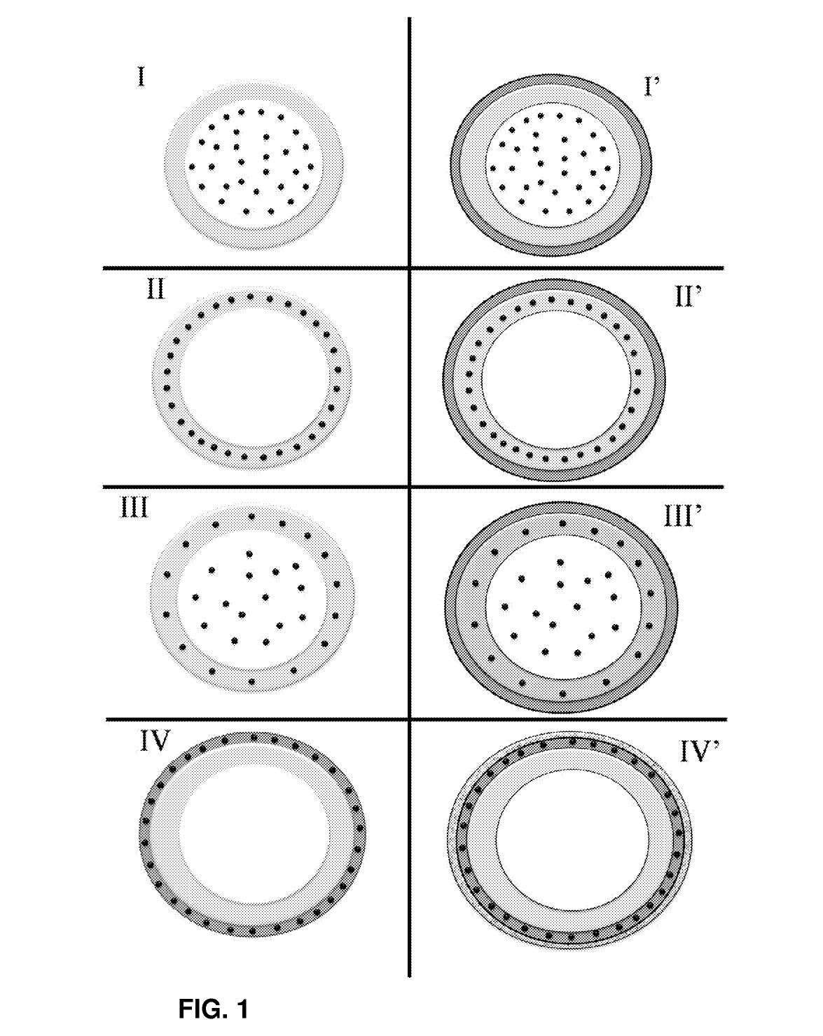

FIGS. 3a and 3b: Low magnification TEM images the carbon nanotubes produced on the layered multiphase supported catalyst I′B4, applying Test A′ (see Tables 8 and 18). For the lower picture, the central coil diameter (D), pitch (P) and nanotube diameter (d) are 70, 40 and 20 nm, respectively. The hCNT length is 1.4 μm for 37 pitches.

FIG. 4: Low magnification TEM image the carbon nanotubes produced on the layered multiphase supported catalyst I″B1, applying Test A′ (see Tables 8 and 18). The central coil diameter (D), pitch (P) and nanotube diameter (d) are 280, 350 and 40 nm, respectively. The hCNT length is 1.4 μm for the 4 regular pitches.

### DETAILED DESCRIPTION OF THE INVENTION

The novelty of the present invention stems from the idea that helicity in carbon nanotubes can be controlled by controlling the nature and thickness of the catalyst support layers that the carbon fed and/or the nanotube has to cross for the nanotube growth. Hence controlling the layered multiphase catalyst support and further that of the layered multiphase supported catalyst, is a key factor to control the helical nanotubes growth.

The layered multiphase supported catalysts of the present invention are made of layered multiphase particles containing catalyst nanoparticles (see FIG. 1). The layered multiphase particles contain one or several particle cores and one or several outer layers. The catalyst nanoparticles, in the layered multiphase supported catalysts, can be:
Mainly in the particle core(s) (Types I and I′);
Mainly in the outer layer(s) (Types II and IV)
Distributed through all of the layers (Type III);
In one of the intermediate layers (Types II′ and IV′);
In the core(s) and intermediate layers (Type III′).

The silica (SiO₂) used as particle core in the present invention to prepare the catalyst is preferably a commercial powder (i.e. Acros Organics) of variable particle size (1 nm<particle size<1 mm).

The alumina (Al₂O₃) used as particle core in the present invention to prepare the catalyst is preferably a commercial powder (i.e. Acros Organics) of particle size ranging from 30 to 60 nm and more preferably between 40 and 50 nm.

The NaY zeolite used as particle core in the present invention to prepare the catalyst is preferably a commercial powder (i.e. UOP) of variable particle size (10 nm<particle size<1 mm).

The double-layer multiphase supported catalysts preparation process comprises the following steps:
Selection of the particle core (central phase) that can be catalyst support (i.e. SiO₂, Al₂O₃, NaY zeolite, other zeolites, fumed silica . . . ) or a supported catalyst (i.e. those prepared by Processes A-F, hereafter).
Selection of the particle surface (outer phase) that can be catalyst support (i.e. fumed silica, fumed alumina . . . ) or a supported catalyst (i.e. fumed silica/metal(s), fumed alumina/metal(s)).
Mixing of the particle core with the particle surface (in the appropriate proportions). The mixing is preferably carried out in a solvent (i.e. water, ethanol, toluene, . . . ).
Reacting the particle core with the particle surface, during the dehydration. The elimination of the water and other generated volatile compounds is achieved using a gas (i.e. N₂, air) flow, a rotary evaporator, azeotropic distillation, a vacuum pump, an oven, a furnace (30° C.<temperature<700° C.), or combinations thereof.
Pelletization of the layered multiphase supported catalyst is optionally performed by pressing, preferably at a pressure of 1-3 ton/cm².
Calcination of the layered multiphase supported catalyst thus prepared is optionally performed in a furnace heated at temperatures varying from 100° C. to 1200° C. The latter calcination can be carried out either before and/or after the pelletization step, if any.

The triple-layer multiphase supported catalysts preparation process is similar to the double-layer process except the fact that the particle core is replaced by a double-layer multiphase supported catalyst.

The tetra-layer multiphase supported catalysts preparation process is also similar to the double-layer process except the fact that the particle core is replaced by a triple-layer multiphase supported catalyst. More layers can also be built applying the same principle to generate other layered multiphase supported catalysts, that are also part of the present invention.

The different steps of the multilayer supported catalyst preparation process can be run in continuous or discontinuous manner.

The helical carbon nanotubes production on the layered multiphase supported catalyst by CCVD comprises the following steps:
Spreading an appropriate amount of layered multiphase supported catalyst on the bed of the fixed bed (i.e. quartz boat), fluidized bed (i.e. sintered quartz plate) or moving bed (i.e. quartz plates, quartz tube, metal tube) reactor.
Activation of the layered multiphase supported catalyst, by heating at appropriate temperature (400-1200° C.), for an appropriate time (i.e. 0-60 min, but preferably 10 min). Inert or reactant gas(es) can be passed over the supported catalyst during that step.
Growing of helical carbon nanotubes on the layered multiphase supported catalyst by passing pure or diluted hydrocarbon at appropriate reaction temperature (400-1200° C., but preferably 700° C.), for an appropriate reaction time (i.e. 2-120 min, but preferably 10-60 min and more preferably 30 min). Diluted hydrocarbon is obtained by mixing at least one hydrocarbon with at least one gas such as N₂, Ar, He, H₂, CO, H₂O, H₂S, etc.
Collection of the crude helical nanotubes, composed of a mixture of carbon nanotubes and spent layered multiphase supported catalyst, either continuously in the case of a moving bed reactor or stepwise in the case of a fixed or fluidized bed reactor.

Description of a Preferred Embodiment of the Present Invention

1. Preparation of the Layered Multiphase Supported Catalysts

The preparation of the layered multiphase supported catalyst is a multistep process that may involve the use of reference- or multiphase-supported catalysts, as starting materials, to build the individual layers. Some reference supported catalysts productions processes are first described (Processes A-E), secondly a process for the production of multiphase catalysts is presented (Process F) and, finally the production of some layered multiphase supported catalysts is presented (Processes G-Q).

1.1. Preparation of Reference Supported Catalysts

The production of some reference supported catalysts used in the present invention are described in processes A, B, C, D and E, hereafter.

Process A:

The metal salt(s) (i.e. 2.11 g of cobalt acetate; Sigma-Aldrich) and 9.5 g of silica gel (i.e. SiO₂ Merck, 130-160 mesh, 6 nm pore size) are added to 50 ml of distilled water. The solution is homogenized for 5 min and then the pH of solution is set to 8.0 by the addition of ammonium hydroxide solution (30 wt. %, Carlo Erba). After homogenization of 6 hours, the pH is set to 8.0 again. The solid product is filtered and washed with distilled water. The so-obtained solid is dried, in an air oven, at 120° C. for 16 hours, to afford 10 g of reference supported catalyst A. After calcination (i.e. at 350° C. in air), it is named Ac.

Process B:

The metal salt(s) (i.e. 2.11 g of cobalt acetate) is added to 5.37 ml of distilled water. After manual homogenization for 5 min, the solution is treated by an ultrasound bath for 30 min (power 80 W). The solution is mixed with 9.5 g of silica gel (i.e. SiO₂ Merck, 130-160 mesh, 6 nm pore size) and homogenized to obtain a wet product of uniform (violet) color. The so-obtained solid is dried, in an air oven, at 130° C. for 16 hours. The dried solid is treated by ball milling for 15 min to afford the reference supported catalyst B. After calcination (i.e. at 350° C. in air), it is named Bc.

Process C:

The metal salt(s) (i.e. 2.11 g of cobalt acetate) is added to 5.37 ml of distilled water. After manual homogenisation for 5 min, the solution is treated by an ultrasound bath for 30 min (Power 80 W). The solution is mixed with the 9.5 g of NaY zeolite (UOP) and homogenized to obtain a wet product of uniform colour. The product is dried, in an air oven, at 130° C. for 16 hours. The dried solid is treated by ball milling for 15 min to afford the reference supported catalyst C. After calcination (i.e. at 350° C. in air), it is named Cc.

TABLE 1
Nature of catalyst support and metal(s) content of
the preferred reference supported catalysts A, B and C.

| Cat. | First | Second | Cat. | Metal(s) (wt %) | | | | |
|---|---|---|---|---|---|---|---|---|
| name | salt | salt | support | Co | Fe | Mo | Ni | Pr |
| A | Co(AcO)₂ | | SiO₂ | 5.0 | | | | |
| Ac | Co(AcO)₂ | | SiO₂ | 5.0 | | | | |
| B | Co(AcO)₂ | | SiO₂ | 5.0 | | | | |
| Bc | Co(AcO)₂ | | SiO₂ | 5.0 | | | | |
| B1 | | Fe(NO₃)₃ | SiO₂ | | 5.0 | | | |
| B1c | | Fe(NO₃)₃ | SiO₂ | | 5.0 | | | |
| B2 | Co(AcO)₂ | Fe(NO₃)₃ | SiO₂ | 1.6 | 1.6 | | | |
| B3 | Co(AcO)₂ | C₁₀H₁₄MoO₆ | SiO₂ | 1.6 | | 1.6 | | |
| B4 | Co(AcO)₂ | Pr(NO₃)₃ | | 4.0 | | | | 1.0 |
| C1 | Co(AcO)₂ | | NaY | 5.0 | | | | |
| Cc1 | Co(AcO)₂ | | NaY | 5.0 | | | | |
| C2 | Co(AcO)₂ | Fe(NO₃)₃ | NaY | 5.0 | 5.0 | | | |
| C3 | Co(AcO)₂ | Ni(OCOCH₃)₂ | NaY | 5.0 | | | 5.0 | |
| C4 | Fe(NO₃)₃ | Ni(OCOCH₃)₂ | NaY | | 5.0 | | 5.0 | |
| C5 | Co(AcO)₂ | Fe(NO₃)₃ | NaY | 2.5 | 5.0 | | 2.5* | |
| C6 | Fe(NO₃)₃ | C₁₀H₁₄MoO₆ | NaY | | 5.0 | 5.0 | | |
| C7 | Co(AcO)₂ | | MFI | 5.0 | | | | |
| C8 | Co(AcO)₂ | Fe(NO₃)₃ | NaY | 1.6 | 1.6 | | | |
| C9 | Co(AcO)₂ | C₁₀H₁₄MoO₆ | NaY | 1.6 | | 1.6 | | |
| C10 | | Fe(NO₃)₃ | NaY | | 5.0 | | | |
| C10c | | Fe(NO₃)₃ | NaY | | 5.0 | | | |
| C11 | Co(AcO)₂ | | NaY | 2.5 | | | | |

*The third metal (Ni) was introduced as Ni(OCOCH₃)₂.

Process D:

A solution is prepared by dissolving the metal salt(s) (i.e.: 2.11 g of Co(AcO)₂.4H₂O) in 4 ml of distilled water. It is then added to 9.5 g of catalyst support (i.e.: Al(OH)₃ powder, fumed silica, amorphous carbon, Al₂O₃ . . . ) contained in a mortar and the product is mixed thoroughly for 10 minutes to obtain a homogeneous powder. Finally, the powder is dried for 16 hours, at 120° C., in an air oven, cooled down to room temperature and ground into a fine powder to obtain the reference supported catalyst D1-D8, depending on the catalyst support and metal(s) (Table 2). After calcination (i.e. at 350° C. in air), they are named Dc1-Dc8, respectively.

TABLE 2
Nature of catalyst support and metal(s) content of
the preferred reference supported catalysts D and Dc.

| Cat. | First | Second | Cat. | Metal(s) (wt %) | | |
|---|---|---|---|---|---|---|
| name | salt | salt | support | Co | Fe | Mo |
| D1 | Co(AcO)₂ | | Al(OH)₃ | 5.0 | | |
| Dc1 | Co(AcO)₂ | | Al(OH)₃ | 5.0 | | |
| D2 | Co(AcO)₂ | | Fum. | 5.0 | | |
| | | | SiO₂ | | | |
| Dc2 | Co(AcO)₂ | | Fum. | 5.0 | | |
| | | | SiO₂ | | | |
| D3 | Co(AcO)₂ | | Am. C | 5.0 | | |
| Dc3 | Co(AcO)₂ | | Am. C | 5.0 | | |
| D4 | Co(AcO)₂ | C₁₀H₁₄MoO₆ | Fum. | 1.6 | | 1.6 |
| | | | SiO₂ | | | |
| D5 | Co(AcO)₂ | C₁₀H₁₄MoO₆ | Al(OH)₃ | 1.6 | | 1.6 |
| D6 | Fe(NO₃)₃ | | Al(OH)₃ | | 5.0 | |
| Dc6 | Fe(NO₃)₃ | | Al(OH)₃ | | 5.0 | |
| D7 | Fe(NO₃)₃ | | Fum. | | 5.0 | |
| | | | SiO₂ | | | |
| Dc7 | Fe(NO₃)₃ | | Fum. | | 5.0 | |
| | | | SiO₂ | | | |
| D8 | Co(AcO)₂ | | Al₂O₃ | 5.0 | | |

Process E:

1.30 g of Co(AcO)₂.4H₂O, 2.17 g of Fe(NO₃)₃.9H₂O (Sigma-Aldrich) and 18.53 g of catalyst support (i.e.: γ-Al₂O₃, Al(OH)₃, SiO₂, NaY zeolite, sepiolite, Clay, Mg₂Si₂O₆, MgO, CaCO₃ . . . ) are introduced into the bowl of a milling apparatus (i.e. vibratory ball mill, P0 Fritsch, containing 1 agate ball of 5 cm in diameter), and milled for 1 hour (t₁), at a vibration amplitude of 2 mm, to obtain a homogeneous powder. The powder (contained in the bowl or in any other recipient) is dried for 1 hour (t₂) in an oven heated to 120° C., in air. Finally, the dried powder is ground into a fine powder by ball milling in the same conditions, during 4 hours (t₃) to obtain the reference supported catalyst E (Table 3), depending on the catalyst support and metal(s). After calcination (i.e. at 350° C. in air), it is named Ec.

The milling apparatus is preferentially a vibratory, a planetary or an industrial mill (i.e. rotating barrel, Submill, Turbula). The vibratory and planetary mills contain ball(s) while the industrial mill contains ball(s), cylinder(s) or mixtures thereof. The milling times t₁ and t₃ depend on the milling apparatus and other experimental conditions, but 25 min is preferred for t₁ and t₂ applying the planetary ball mill (P6 Fritsch).

TABLE 3
Nature of catalyst support and metal(s) content of
the preferred reference supported catalysts E.

| Cat. | First | Second | Cat. | Metal(s) (wt %) | | |
|---|---|---|---|---|---|---|
| name | salt | salt | support | Co | Fe | Mo |
| E1 | Co(AcO)₂ | Fe(NO₃)₃ | γ-Al₂O₃ | 1.6 | 1.6 | |
| E2 | Co(AcO)₂ | Fe(NO₃)₃ | Al(OH)₃ | 1.6 | 1.6 | |
| E3 | Co(AcO)₂ | | SiO₂ | 1.6 | | |
| E4 | Co(AcO)₂ | Fe(NO₃)₃ | SiO₂ | 1.6 | 1.6 | |
| E5 | Co(AcO)₂ | Fe(NO₃)₃ | NaY | 5.0 | 2.13 | |
| E6 | Co(AcO)₂ | Fe(NO₃)₃ | NaY | 1.5 | 1.5 | |
| E7 | Co(AcO)₂ | Fe(NO₃)₃ | NaY | 5.0 | 5.0 | |
| E8 | Co(AcO)₂ | Fe(NO₃)₃ | Sepiolite | 1.6 | 1.6 | |
| E9 | Co(AcO)₂ | Fe(NO₃)₃ | Clay* | 1.6 | 1.6 | |
| E10 | Co(AcO)₂ | Fe(NO₃)₃ | Mg₂Si₂O₆ | 1.6 | 1.6 | |
| E11 | Co(AcO)₂ | | MgO | 5.0 | | |
| E12 | Co(AcO)₂ | Fe(NO₃)₃ | MgO | 1.6 | 1.6 | |
| E13 | Co(AcO)₂ | MoO₂(acac)₂ | MgO | 1.6 | | 1.6 |
| E14 | Fe(NO₃)₃ | MoO₂(acac)₂ | MgO | | 1.6 | 1.6 |
| E15 | Fe(NO₃)₃ | Fe(NO₃)₃ | CaCO₃ | 1.6 | 1.6 | |

*The Clay used was Montmorillonite.

1.2. Preparation of Multiphase Supported Catalysts

Process F:

2.11 g of cobalt acetate are added to 5.37 ml of distilled water. After manual homogenisation for 5 min, the solution is treated by an ultrasound bath for 30 min (Power 80 W). The solution is mixed with the 4.75 g of silica gel (i.e. SiO₂ Merck, 130-160 mesh, 6 nm pore size) and 4.75 g of NaY zeolite. It is then homogenized to obtain a wet product of uniform (violet) colour. The product is dried, in an air oven, at 130° C. for 16 hours. The dried solid is treated by ball milling for 15 min to afford the multiphase supported catalyst F. After calcination (i.e. at 350° C. in air), it is named Fc.

TABLE 4
Nature of catalyst support and metal(s) content of
some preferred multiphase supported catalysts F.

| Cat. | First | Second | Cat. | Metal(s) (wt %) | | | | |
|---|---|---|---|---|---|---|---|---|
| name | salt | salt | support | Co | Fe | V | Mo | Pr |
| F | Co(AcO)₂ | | SiO₂/NaY | 5.0 | | | | |
| Fc | Co(AcO)₂ | | SiO₂/NaY | 5.0 | | | | |

1.3. Processes for the Production of Layered Multiphase Supported Catalysts

Some processes for the production the different types (see FIG. 1) of layered multiphase supported catalysts are presented hereafter (Processes G-Q).

1.3A. Metals Distributed Through the Particle Core and Outer Layer (Type III)

Process G:

10 g of reference supported catalyst A, B, C, D, E, F, Ac, Bc, Cc, Dc, Ec or Fc are used to form a mixture with 10 g of fumed silica (i.e. fumed SiO₂ Degussa) and 6.5 ml of distilled water. The so-obtained gel is dried at 130° C. for 5 hours to afford the layered multiphase supported catalyst GA, GB, GC, GD, GE, GF, GAc, GBc, GCc, GDc, GEc or GFc, respectively.

The layered multiphase supported catalysts GA, GB, GC, GD, GE and GF are of Type III, while GAc, GBc, GCc, GDc, GEc or GFc are of Type I.

TABLE 5
Nature of catalyst support and metal(s) content of
some preferred multiphase supported catalysts G.

| Cat. | Particle | Core | Particle | Metal(s) (wt %) | | |
|---|---|---|---|---|---|---|
| name | Core*^{,}** | support | coating 1 | Co | Fe | Mo |
| GA | A | SiO₂ | Fum. SiO₂ | 2.5 | | |
| GB | B | SiO₂ | Fum. SiO₂ | 2.5 | | |
| GB1 | B1 | SiO2 | Fum. | 2.5 | | |
| | | | SiO2 | | | |
| GB3 | B3 | SiO2 | Fum. SiO₂ | 0.8 | | 0.8 |
| GC1 | C1 | NaY | Fum. SiO₂ | 2.5 | | |
| GC2 | C2 | NaY | Fum. SiO₂ | 2.5 | 2.5 | |
| GC9 | C9 | NaY | Fum. | 0.8 | | 0.8 |
| | | | SiO2 | | | |
| GC10 | C10 | NaY | Fum. | | 2.5 | |
| | | | SiO2 | | | |
| GD1 | D1 | Al(OH)3 | Fum. SiO₂ | 2.5 | | |
| GD5 | D5 | Al(OH)3 | Fum. | 0.8 | | 0.8 |
| | | | SiO2 | | | |
| GD6 | D6 | Al(OH)3 | Fum. | | 2.5 | |
| | | | SiO2 | | | |
| GD7 | D7 | Fum. SiO2 | Fum. | | 2.5 | |
| | | | SiO2 | | | |
| GE5 | E5 | NaY | Fum. SiO₂ | 2.5 | 1.1 | |
| GE6 | E6 | NaY | Fum. SiO₂ | 0.7 | 0.7 | |
| GE7 | E7 | NaY | Fum. SiO₂ | 2.5 | 2.5 | |

*x of Dx varies from 1 to 8, depending on the support and metal(s) of the catalyst D (see Table 2).
**y of Ey varies from 1 to 15 depending on the support and metal(s) of the catalyst E (see Table 3).

1.3.2. Very Little or No Metals in the Catalyst Particle Outer Layer (Type I)

Process H:

10 g of reference supported catalyst A, B, C, D, E or F are introduced into a single neck glass balloon, equipped with a magnetic stirrer and 50 ml of dried ethanol are added. 38 ml (equivalent of 10 g of SiO₂) of Si(OEt)₄ (99 wt. % solution in ethanol, Merck) are added to the stirred suspension and the stirring is maintained for one hour. Afterwards, 1.0 equivalent of water is added for the hydrolysis of the Si(OEt)₄ and the solvent is evaporated to dryness using a rotary evaporator. The so-obtained solid is dried at 130° C. for 15 hours to afford the layered multiphase supported catalyst HA, HB, HC, HD, HE or HF, respectively.

Process H′:

Same as Process H, but no water is added. The layered multiphase supported catalysts obtained are named H′A, H′B, H′C, H′D, H′E or H′F, respectively.

Process H″:

Same as Process H′, but the ethanol is replaced by toluene. The layered multiphase supported catalysts obtained are named H″A, H″B, H″C, H″D, H″E or H″F, respectively.

Process H″′:

Same as Process H, but the ethanol is replaced by toluene. The layered multiphase supported catalysts obtained are named H″′A, H″′B, H′″C, H′″D, H′″E or H′″F, respectively.

Process H^{IV}:

10 g of reference supported catalyst A, B, C, D, E or F are introduced into a single neck glass balloon, equipped with a magnetic stirrer and 50 ml of toluene are added. 12.42 ml (equivalent of 3.33 g of SiO₂) of Si(OEt)₄ (99 wt. % solution in ethanol, Merck) are added to the stirred suspension and the stirring is maintained for one hour. Afterwards, the solvent is evaporated to dryness using a rotary evaporator. The so-obtained solid is dried at 130° C. for 15 hours to afford the layered multiphase supported catalyst H^{IV}A, H^{IV}B, H^{IV}C, H^{IV}D, H^{IV}E or H^{IV}F, respectively.

TABLE 6
Nature of catalyst support and metal(s) content of
some preferred multiphase supported catalysts H, H′, H″,
H′″, and H^{IV}, applying catalysts A-F.

| Cat. | Particle | Core | Particle | Metal(s) (wt %) | | | |
|---|---|---|---|---|---|---|---|
| name | core | support | coating 1 | Co | Fe | Mo | Pr |
| HB | B | SiO₂ | Si(OH)₄ | 2.5 | | | |
| HB1 | B1 | SiO2 | Si(OH)4 | | 2.5 | | |
| HB3 | B3 | SiO2 | Si(OH)4 | 0.8 | | 0.8 | |
| HC10 | C10 | NaY | Si(OH)4 | | 2.5 | | |
| HD6 | D6 | Al(OH)₃ | Si(OH)4 | | 2.5 | | |
| HD7 | D7 | Fum. SiO2 | Si(OH)4 | | 2.5 | | |
| H′A | A | SiO₂ | Si(OH)₄ | 2.5 | | | |
| H″A | A | SiO₂ | Si(OH)₄ | 2.5 | | | |
| H″B1 | B1 | SiO2 | Si(OH)4 | 2.5 | | | |
| H′′B4 | B4 | SiO2 | Si(OH)4 | 2.0 | | | 0.5 |
| H′′C8 | C8 | NaY | Si(OH)4 | 0.8 | 0.8 | | |
| H″C11 | C11 | NaY | Si(OH)4 | 1.25 | | | |
| H′″A | A | SiO2 | Si(OH)₄ | 2.5 | | | |
| H′″B | B | SiO2 | Si(OH)₄ | 2.5 | | | |
| H^{IV}A | A | SiO2 | Si(OH)₄ | 3.75 | | | |

Processes H, H′, H″, H″′ and H^{IV} can also be conducted applying the calcined versions of the reference catalysts A-F. The generated catalysts are presented in Table 7.

TABLE 7
Nature of catalyst support and metal(s) content of
some preferred multiphase supported catalysts H, H′, H″,
H′″, and H^{IV}, applying catalysts Ac-Fc.

| Cat. | Particle | Core | Particle | Metal(s) (wt %) | | | | |
|---|---|---|---|---|---|---|---|---|
| name | core | support | coating 1 | Co | Fe | V | Mo | Pr |
| HAc | Ac | SiO₂ | Si(OH)₄ | 2.5 | | | | |
| HBc | Bc | SiO₂ | Si(OH)₄ | 2.5 | | | | |
| H′Ac | Ac | SiO₂ | Si(OH)₄ | 2.5 | | | | |
| H′Bc | Bc | SiO₂ | Si(OH)₄ | 2.5 | | | | |
| H″Ac | Ac | SiO₂ | Si(OH)₄ | 2.5 | | | | |
| H″Bc | Bc | SiO₂ | Si(OH)₄ | 2.5 | | | | |

Process I:

10 g of reference supported catalyst A, B, C, D, E or F are introduced into a single neck glass balloon, equipped with a magnetic stirrer and 50 ml of dried ethanol are added. 33.4 g (equivalent of 10 g of Al₂O₃) of Al(OEt)₃ (Sigma-Aldrich 97 wt. %, solid) are added to the stirred suspension and the stirring is maintained for one hour. Afterwards, 1.0 equivalent of water is added for the hydrolysis of the Al(OEt)₃ and the solvent is evaporated to dryness using a rotary evaporator. The so-obtained solid is dried at 130° C. for 15 hours to afford the layered multiphase supported catalyst IA, IB, IC, ID, IE or IF, respectively.

Process I′:

Same as Process H, but no water is added. The layered multiphase supported catalysts obtained are named I′A, I′B, I′C, I′D, I′E or I′F, respectively.

Process I″:

Same as Process H′, but the ethanol is replaced by toluene. The layered multiphase supported catalysts obtained are named I″A, I″B, I″C, I″D, I″E or I″F, respectively.

Process I″′:

10 g of reference supported catalyst A, B, C, D, E or F are introduced into a single neck glass balloon, equipped with a magnetic stirrer and 50 ml of toluene are added. 11.0 g (equivalent of 3.33 g of Al₂O₃) of Al(OEt)₃ (Sigma-Aldrich 97 wt. %, solid) are added to the stirred suspension and the stirring is maintained for one hour. Afterwards, 1.0 equivalent of water is added for the hydrolysis of the Al(OEt)₃ and the solvent is evaporated to dryness using a rotary evaporator. The so-obtained solid is dried at 130° C. for 15 hours to afford the layered multiphase supported catalyst I′″A, I′″B, I′″C, I′″D, I′″E or I′″F, respectively.

TABLE 8
Nature of catalyst support and metal(s) content of
some preferred multiphase supported catalysts I, I′, I″ and
I′″, applying catalysts A-F.

| Cat. | Particle | Core | Particle | Metal(s) (wt %) | | | | |
|---|---|---|---|---|---|---|---|---|
| name | core | support | coating 1 | Co | Fe | V | Mo | Pr |
| IA | A | SiO₂ | Al(OH)₃ | 2.5 | | | | |
| IB | B | SiO₂ | Al(OH)₃ | 2.5 | | | | |
| I′A | A | SiO₂ | Al(OH)₃ | 2.5 | | | | |
| I′B | B | SiO₂ | Al(OH)₃ | 2.5 | | | | |
| I′B4 | B4 | SiO₂ | Al(OH)₃ | 2.0 | | | | 0.5 |
| I″A | A | SiO₂ | Al(OH)₃ | 2.5 | | | | |
| I″B | B | SiO₂ | Al(OH)₃ | 2.5 | | | | |
| I″B1 | B1 | SiO₂ | Al(OH)₃ | | 2.5 | | | |
| I′″A | A | SiO2 | Al(OH)₃ | 3.75 | | | | |

Processes I, I′, I″ and I″′ can also be conducted applying the calcined versions of the reference catalysts A-F. The generated catalysts are presented in Table 9.

TABLE 9
Nature of catalyst support and metal(s) content of
some preferred multiphase supported catalysts I, I′, I″ and
I′″, applying catalysts Ac-Fc.

| Cat. | Particle | Core | Particle | Metal(s) (wt %) | | | | |
|---|---|---|---|---|---|---|---|---|
| name | core | support | coating 1 | Co | Fe | V | Mo | Pr |
| IAc | Ac | SiO₂ | Al(OH)₃ | 2.5 | | | | |
| IBc | Bc | SiO₂ | Al(OH)₃ | 2.5 | | | | |
| I′Ac | Ac | SiO₂ | Al(OH)₃ | 2.5 | | | | |
| I′Bc | Bc | SiO₂ | Al(OH)₃ | 2.5 | | | | |
| I″Ac | Ac | SiO₂ | Al(OH)₃ | 2.5 | | | | |
| I″Bc | Bc | SiO₂ | Al(OH)₃ | 2.5 | | | | |

Process J′:

10 g of reference supported catalyst A, B, C, D, E or F are introduced into a single neck glass balloon, equipped with a magnetic stirrer and 50 ml of dried ethanol are added. 10 g of amorphous carbon (i.e. Norit A) are added to the stirred suspension and the stirring is maintained for one hour. Afterwards, the solvent is evaporated to dryness using a rotary evaporator. The so-obtained solid is dried at 130° C. for 15 hours to afford the layered multiphase supported catalyst J′A, J′B, J′C, J′D, J′E or J′F, respectively.

Process J″:

Same as Process J′, but the ethanol is replaced by toluene. The layered multiphase supported catalysts obtained are named J″A, J″B, J″C, J″D, J″E or J″F, respectively.

TABLE 10
Nature of catalyst support and metal(s) content of
some preferred layered multiphase supported
catalysts J′ and J″, applying catalysts A-F.

| Cat. | Particle | Core | Particle | Metal(s) (wt %) | | | | |
|---|---|---|---|---|---|---|---|---|
| name | core | support | coating 1 | Co | Fe | V | Mo | Pr |
| J′A | A | SiO₂ | Am. C | 2.5 | | | | |
| J′B | B | SiO₂ | Am. C | 2.5 | | | | |
| J″A | A | SiO₂ | Am. C | 2.5 | | | | |
| J″B | B | SiO₂ | Am. C | 2.5 | | | | |
| J′B1 | B1 | SiO₂ | Am. C | | 2.5 | | | |
| J′B4 | B4 | SiO₂ | Am. C | 2.0 | | | | 0.5 |

Processes J′ and J″ can also be conducted applying the calcined versions of the reference catalysts A-F. The generated catalysts are presented in Table 11.

TABLE 11
Nature of catalyst support and metal(s) content of
some preferred layered multiphase supported
catalysts J′ and J″, applying catalysts Ac-Fc.

| Cat. | Particle | Core | Particle | Metal(s) (wt %) | | | | |
|---|---|---|---|---|---|---|---|---|
| name | core | support | coating 1 | Co | Fe | V | Mo | Pr |
| J′Ac | Ac | SiO₂ | Am. C | 2.5 | | | | |
| J′Bc | Bc | SiO₂ | Am. C | 2.5 | | | | |
| J″Ac | Ac | SiO₂ | Am. C | 2.5 | | | | |
| J″Bc | Bc | SiO₂ | Am. C | 2.5 | | | | |

1.3.3. Very Little or No Metals in the Catalyst Particle Core (Type II)

Process K′:

10 g of reference supported catalyst D1, D2, D3, Dc1, Dc2 or Dc3 are introduced into a single neck glass balloon, equipped with a magnetic stirrer and 50 ml of dried ethanol are added. 10 g of silica gel or alumina are added to the stirred suspension and the stirring is maintained for one hour. Afterwards, the solvent is evaporated to dryness using a rotary evaporator. The so-obtained solid is dried at 130° C. for 15 hours to afford different layered multiphase supported catalysts, depending on the particles core:
Applying Silica gel: K′D1si, K′D2si, K′D3si, K′Dc1si, K′Dc2si or K′Dc3si, respectively.
Applying Alumina: K′D1al, K′D2al, K′D3al, K′Dc1al, K′Dc2al or K′Dc3al, respectively.

Other particles cores such as CaCO₃, MgO, Mg₂Si₂O₆, sepiolite . . . can also be used, applying process K′.

TABLE 12
Nature of catalyst support and metal(s) content of
some preferred multiphase supported catalysts
K′, prepared using ethanol.

| Cat. | Particle | Particle | Coating 1 | Metal(s) (wt %) | | |
|---|---|---|---|---|---|---|
| name | core | coating 1 | support | Co | Fe | Mo |
| K′D1si | Silicagel | D1 | Al(OH)₃ | 2.5 | | |
| K′Dc1si | Silicagel | Dc1 | Al(OH)₃ | 2.5 | | |
| K′D2si | Silicagel | D2 | Fum. SiO₂ | 2.5 | | |
| K′Dc2si | Silicagel | Dc2 | Fum. SiO₂ | 2.5 | | |
| K′D3si | Silicagel | D3 | Am. C | 2.5 | | |
| K′Dc3si | Silicagel | Dc3 | Am. C | 2.5 | | |
| K′D1al | Alumina | D1 | Al(OH)₃ | 2.5 | | |
| K′Dc1al | Alumina | Dc1 | Al(OH)₃ | 2.5 | | |
| K′D2al | Alumina | D2 | Fum. SiO₂ | 2.5 | | |
| K′Dc2al | Alumina | Dc2 | Fum. SiO₂ | 2.5 | | |
| K′D3al | Alumina | D3 | Am. C | 2.5 | | |
| K′Dc3al | Alumina | Dc3 | Am. C | 2.5 | | |
| K′D5si | Silicagel | D5 | Fum. SiO₂ | 0.8 | | 0.8 |
| K′D6si | Silicagel | D6 | Fum. SiO₂ | | 2.5 | |
| K′D8si | Silicagel | D8 | Fum. SiO₂ | 2.5 | | |

Process K′ can also be used to produce multiphase catalyst supports free of metals, named Ke′. In that case, the reference supported catalysts D1, D2 and D3 are replaced by Al(OH)₃ powder, fumed silica or amorphous carbon, respectively. Depending on the particle core and coating nature (i.e. Al(OH)₃, Fum. SO₂, or Am. C) the corresponding layered multiphase catalyst supports free of metals, are named K′Al—, K′Fu- or K′Am—, respectively. Al, Fu and Am stand for Al(OH)₃, Fum. SO₂ and Am. C, respectively:
Applying Silica gel: K′Alsi, K′Fusi or K′Amsi, respectively;
Applying Alumina: K′Alal, K′Fual or K′Amal, respectively;

Process K″:

Same as Process K′, but the ethanol is replaced by toluene. Different layered multiphase supported catalysts are obtained, depending on the particles core:
Applying Silica gel: K″D1si, K″D2si, K″D3si, K″Dc1si, K″Dc2si or K″Dc3si, respectively.
Applying Alumina: K″D1al, K″D2al, K″D3al, K″Dc1al, K″Dc2al or K″Dc3al, respectively.
Applying NaY zeolite: K″D1ze, K″D2ze, K″D3ze, K″Dc1ze, K″Dc2ze or K″Dc3ze, respectively.

Other particles cores such as CaCO₃, MgO, Mg₂Si₂O₆, sepiolite . . . can also be used, applying process K″.

TABLE 13
Nature of catalyst support and metal(s) content of
some preferred multiphase supported catalysts K″, prepared
using toluene.

| Cat. | Particle | Particle | Coating 1 | Co |
|---|---|---|---|---|
| name | core | coating 1 | support | (wt %) |
| K″D1si | Silicagel | D1 | Al(OH)₃ | 2.5 |
| K″Dc1si | Silicagel | Dc1 | Al(OH)₃ | 2.5 |
| K″D2si | Silicagel | D2 | Fum. SiO₂ | 2.5 |
| K″Dc2si | Silicagel | Dc2 | Fum. SiO₂ | 2.5 |
| K″D3si | Silicagel | D3 | Am. C | 2.5 |
| K″Dc3si | Silicagel | Dc3 | Am. C | 2.5 |
| K″D1al | Alumina | D1 | Al(OH)₃ | 2.5 |
| K″Dc1al | Alumina | Dc1 | Al(OH)₃ | 2.5 |
| K″D2al | Alumina | D2 | Fum. SiO₂ | 2.5 |
| K″Dc2al | Alumina | Dc2 | Fum. SiO₂ | 2.5 |
| K″D3al | Alumina | D3 | Am. C | 2.5 |
| K″Dc3al | Alumina | Dc3 | Am. C | 2.5 |

Process K″ can also be used to produce multiphase catalyst supports free of metals, named Ke″. In that case, the reference supported catalysts D, D′ and D″ are replaced by Al(OH)₃ powder, fumed silica or amorphous carbon, respectively. Depending on the particle core and coating nature (i.e. Al(OH)₃, Fum. SO₂, or Am. C) the corresponding layered multiphase catalyst supports free of metals, are named K″Al—, K″Fu- or K″Am—, respectively. Al, Fu and Am stand for Al(OH)₃, Fum. SO₂ and Am. C, respectively:
Applying Silica gel: K″Alsi, K″Fusi or K″Amsi, respectively;
Applying Alumina: K″Alal, K″Fual or K″Amal, respectively;

1.3.4. Concentric Layered Triple-Layers Catalyst Supports Containing Metal(s) Mainly in the Particle Core (Type I′)

Process L:

Layered multiphase supported catalysts of Type I (i.e. produced by processes G, H, H′, Ti″, I, I′, I″, J′ or J″) are exposed to a second coating applying one of the processes H, H′, Ti″, I, I′, I″, J′ or J″ to provide layered multiphase supported catalysts L.

1.3.5. Concentric Layered Triple-Layers Catalyst Supports Containing Metal(s) Mainly in the First Coating of the Particle Core (Type II′)

Process M:

Layered multiphase supported catalysts of Type II (i.e. produced by processes K′ or K″) are exposed to a second coating applying one of the processes G, H, H′, Ti″, I, I′, I″, J′ or J″ to provide layered multiphase supported catalysts M.

1.3.6. Concentric Layered Triple-Layers Catalyst Supports Containing Metal(s) Mainly in the First Coating and the Particle Core (Type III′)

Process N

(Layered multiphase supported catalyst production): Layered multiphase supported catalysts of Type III (i.e. produced by process G) are exposed to a second coating applying one of the processes G, H, H′, Ti″, I, I′, I″, J′ or J″ to provide layered multiphase supported catalysts N.

The number of combinations affording layered multiphase supported catalysts L, M and N being very large, they are not summarized here but, they are part of the present invention.

1.3.7. Concentric Layered Triple-Layers Catalyst Supports Containing Metal(s) Mainly in the Second Coating of the Particle Core (Type IV)

Process O:

10 g of reference supported catalyst D1, D2, D3, Dc1, Dc2 or Dc3 are introduced into a single neck glass balloon, equipped with a magnetic stirrer and 50 ml of dried ethanol are added. 10 g of layered multiphase catalyst support free of metals, produced by processes Ke′ or Ke″ are added to the stirred suspension and the stirring is maintained for one hour. Afterwards, the solvent is evaporated to dryness using a rotary evaporator. The so-obtained solid is dried at 130° C. for 15 hours to afford different layered multiphase supported catalysts 0, depending on the particles core, and coatings:
Depending on the particle core first coating nature (i.e. Al(OH)₃, Fum. SO₂, or Am. C) the corresponding layered multiphase supported catalysts is named —Al—, -Fu- or —Am—, respectively.
Applying Silica gel as particle core we have, respectively:
   OD1Alsi, OD2Alsi, OD3Alsi, ODc1Alsi, ODc2Alsi or ODc3Alsi;
   OD1Fusi, OD2Fusi, OD3Fusi, ODc1Fusi, ODc2Fusi or ODc3Fusi;
   OD1Amsi, OD2Amsi, OD3Amsi, ODc1Amsi, ODc2Amsi or ODc3Amsi.
Applying Alumina as particle core we have, respectively:
   OD1Alal, OD2Alal, OD3Alal, ODc1Alal, ODc2Alsi or ODc3Alsi;
   OD1Fual, OD2Fual, OD3Fual, ODc1Fual, ODc2Fusi or ODc3Fusi;
   OD1Amal, OD2Amal, OD3Amal, ODc1Amal, ODc2Amal or ODc3Amal.

Other particles cores such as CaCO₃, MgO, Mg₂Si₂O₆, sepiolite . . . can also be used, applying process 0.

TABLE 14
Nature of catalyst support and metal(s) content of
some multiphase supported catalysts O, with D1 as second coating.

| Cat. | Particle | Particle | Particle | Metal(s) (wt %) | | | | |
|---|---|---|---|---|---|---|---|---|
| name | core | coating 1 | coating 2 | Co | Fe | V | Mo | Pr |
| OD1Alsi | Silicagel | Al(OH)₃ | D1 | 2.5 | | | | |
| OD1Fusi | Silicagel | Fum. SiO₂ | D1 | 2.5 | | | | |
| OD1Amsi | Silicagel | Am. C | D1 | 2.5 | | | | |
| OD1Alal | Alumina | Al(OH)₃ | D1 | 2.5 | | | | |
| OD1Fual | Alumina | Fum. SiO₂ | D1 | 2.5 | | | | |
| OD1Amal | Alumina | Am. C | D1 | 2.5 | | | | |

TABLE 15
Nature of catalyst support and metal(s) content of
some multiphase supported catalysts O, with D2 as second coating.

| Cat. | Particle | Particle | Particle | Metal(s) (wt %) | | | | |
|---|---|---|---|---|---|---|---|---|
| name | core | coating 1 | coating 2 | Co | Fe | V | Mo | Pr |
| OD2Alsi | Silicagel | Al(OH)₃ | D2 | 2.5 | | | | |
| OD2Fusi | Silicagel | Fum. | D2 | 2.5 | | | | |
| | | SiO₂ | | | | | | |
| OD2Amsi | Silicagel | Am. C | D2 | 2.5 | | | | |
| OD2Alal | Alumina | Al(OH)₃ | D2 | 2.5 | | | | |
| OD2Fual | Alumina | Fum. | D2 | 2.5 | | | | |
| | | SiO₂ | | | | | | |
| OD2Amal | Alumina | Am. C | D2 | 2.5 | | | | |

TABLE 16
Nature of catalyst support and metal(s) content of
some multiphase supported catalysts O, with D3,
D6 or D7 as second coating.

| Cat. | Particle | Particle | Particle | Metal(s) (wt %) | | | | |
|---|---|---|---|---|---|---|---|---|
| name | core | coating 1 | coating 2 | Co | Fe | V | Mo | Pr |
| OD3Alsi | Silicagel | Al(OH)₃ | D3 | 2.5 | | | | |
| OD3Fusi | Silicagel | Fum. | D3 | 2.5 | | | | |
| | | SiO₂ | | | | | | |
| OD3Amsi | Silicagel | Am. C | D3 | 2.5 | | | | |
| OD3Alal | Alumina | Al(OH)₃ | D3 | 2.5 | | | | |
| OD3Fual | Alumina | Fum. | D3 | 2.5 | | | | |
| | | SiO₂ | | | | | | |
| OD3Amal | Alumina | Am. C | D3 | 2.5 | | | | |
| OD6Alal | Alumina | Al(OH)₃ | D6 | | 2.5 | | | |
| OD7Alal | Alumina | Al(OH)₃ | D7 | | 2.5 | | | |

Process O can also be used to produce layered multiphase catalyst supports free of metals. In that case, the reference supported catalysts D1, D2 and D3 are replaced by Al(OH)₃ powder, fumed silica or amorphous carbon, respectively. Depending on the particle core (i.e. silica, alumina, zeolite) and its first and second coatings nature (i.e. Al(OH)₃, Fum. SO₂, Am. C) the layered multiphase catalyst supports free of metals, are named:
Applying Silica gel as particle core we have, respectively:
   OAlAlsi, OFuAlsi, OAmAlsi;
   OAlFusi, OFuFusi, OAmFusi;
   OAlAmsi, OFuAmsi, OAmAmsi.
Applying Alumina as particle core we have, respectively:
   OAlAlal, OFuAlal, OAmAlal;
   OAlFual, OFuFual, OAmFual;
   OAlAmal, OFuAmal, OAmAmal.

Other particles cores such as CaCO₃, MgO, Mg₂Si₂O₆, sepiolite . . . can also be used, applying process O.

1.3.8. Concentric Layered Tetra-Layers Catalyst Supports Containing Metal(s) Mainly in the Second Coating of the Particle Core (Type IV′)

Process P:

Layered multiphase supported catalysts of Type IV (i.e. produced by process O) are exposed to a third coating applying one of the processes G, H, H′, Ti″, I, I′, I″, J′ or J″ to provide layered multiphase supported catalysts P.

1.3.9. Concentric Layered Tetra-Layers Catalyst Supports Containing Metal(s) Mainly in the Catalyst Particle Outer Layer (Type V)

Process Q:

Layered multiphase catalyst supports free of metals (i.e. produced by process O) are exposed to a second coating applying one of the processes K′ or K″ to provide layered multiphase supported catalysts Q.

The number of combinations affording layered multiphase supported catalysts P and Q being very large, they are not summarized here but, they are part of the present invention.

2. Carbon Nanotubes Production on the Layered Multiphase Supported Catalysts

Catalyst tests of the supported catalysts were performed preferably, in the fixed bed reactor, applying MWNTs production conditions (Test A, Test B, Test C, Test F), DWNTs production conditions (Test D) or SWNTs production conditions (Test E), described hereafter, to measure the activity of the catalysts for carbon nanotubes synthesis. The gas flows hereafter are measured by mass flow meters (Bronkhorst), at 20° C. Catalytic tests were also performed in a fluidized bed reactor, applying Test F.

Test A:

1 g of supported catalyst is spread on a 70 cm long quartz boat, made of a half tube of 6 cm in diameter. The boat is introduced into a quartz tube reactor of 7 cm in diameter and flushed with nitrogen (2 l/min) for 4 min at 25° C. The reactor is introduced into a furnace preheated at 700° C. (reaction temperature) and the nitrogen flow is maintained for 10 min. The nitrogen flow is then replaced by a C₂H₄ flow of 4 l/min for 20 minutes (reaction time). The C₂H₄ flow is replaced by a N₂ flow of 2 l/min, the reactor is removed from the furnace and the N₂ flow is maintained for 10 min. After cooling to 25° C., the boat is removed from the reactor and the product is collected.

Test A′:

0.25 g of supported catalyst are spread on a 25 cm long quartz boat, made of a half tube of 3 cm in diameter. The boat is introduced into a quartz tube reactor of 4 cm in diameter and flushed with nitrogen (416 ml/min) for 5 min at 25° C. The reactor is introduced into a furnace preheated at 700° C. (reaction temperature) and the nitrogen flow is maintained for 10 min. The nitrogen flow is then replaced by a C₂H₄ flow of 800 ml/min for 20 minutes (reaction time). The C₂H₄ flow is replaced by a N₂ flow of 416 ml/min, the reactor is removed from the furnace and the N₂ flow is maintained for 10 min. After cooling to 25° C., the boat is removed from the reactor and the product is collected.

Test A″:

0.25 g of supported catalyst are spread on a 25 cm long quartz boat, made of a half tube of 3 cm in diameter. The boat is introduced into a quartz tube reactor of 4 cm in diameter and flushed with nitrogen (300 ml/min) for 5 min at 25° C. The reactor is introduced into a furnace preheated at 700° C. (reaction temperature) and the nitrogen flow is maintained for 10 min. The nitrogen flow is then replaced by a C₂H₂ flow of 30 ml/min for 20 minutes (reaction time). The C₂H₂ flow is replaced by a N₂ flow of 300 ml/min, the reactor is removed from the furnace and the N₂ flow is maintained for 10 min. After cooling to 25° C., the boat is removed from the reactor and the product is collected.

Test A′″:

0.25 g of supported catalyst are spread on a 70 cm long quartz boat, made of a half tube of 6 cm in diameter. The boat is introduced into a quartz tube reactor of 7 cm in diameter and flushed with nitrogen (2 l/min) for 4 min at 25° C. The reactor is introduced into a furnace preheated at 700° C. (reaction temperature) and the nitrogen flow is maintained for 10 min. A C₂H₄ flow of 0.8 l/min and a flow of N2 of 0.4 lt/min are used for 20 minutes (reaction time). The C₂H₄ flow is replaced by a N₂ flow of 2 l/min, the reactor is removed from the furnace and the N₂ flow is maintained for 10 min. After cooling to 25° C., the boat is removed from the reactor and the product is collected.

Test A^{IV}:

0.5 g of supported catalyst are spread on a 70 cm long quartz boat, made of a half tube of 6 cm in diameter. The boat is introduced into a quartz tube reactor of 7 cm in diameter and flushed with nitrogen (2 l/min) for 4 min at 25° C. The reactor is introduced into a furnace preheated at 700° C. (reaction temperature) and the nitrogen flow is maintained for 10 min. A C₂H₄ flow of 0.1 l/min and a flow of N₂ of 0.5 l/min are used for 20 minutes (reaction time). The C₂H₄ flow is replaced by a N₂ flow of 2 l/min, the reactor is removed from the furnace and the N₂ flow is maintained for 10 min. After cooling to 25° C., the boat is removed from the reactor and the product is collected.

Test B:

Same as “Test A”, but only 2.5 g of supported catalyst are used and the C₂H₄ flow is set to 1 l/min instead of 4 l/min.

Test B′:

Same as “Test A′″”, but only 0.5 g of supported catalyst are used.

Test B″:

Same as “Test A^{IV}”, but only 0.25 g of supported catalyst are used.

Test B′″:

Same as “Test A^{III}”, but only 2.0 g of supported catalyst are used.

Test B^{IV}:

Same as “Test A^{IV}”, but only 0.33 g of supported catalyst are used.

Test C:

Same as “Test A”, but only 2.5 g of supported catalyst are used instead of 10 g.

Test D:

Same as “Test A”, but only 4 g of supported catalyst are used and the C₂H₄ reactant flow is replaced by a CH₄/H₂ flow set to 1 l/min each. The reaction temperature and time are 950° C. and 15 min, respectively.

Test E:

Same as “Test A”, but 40 g of supported catalyst are used and the C₂H₄ reactant flow is replaced by a CH₄/He/H₂ flow set to 2/1.5/0.5 l/min, respectively. The reaction temperature and time are 950° C. and 6 min, respectively.

Test F:

1 g of supported catalyst is spread on the bottom of the fluidized bed reactor, made of a vertical tube of 3 cm in diameter containing a sintered glass filter at its bottom. The reactor is flushed with nitrogen (2 l/min) for 5 min at 25° C. The reactor is introduced into a furnace preheated at 700° C. (reaction temperature) and the nitrogen flow is maintained for 10 min. The nitrogen flow is then replaced by a C₂H₄ flow of 4 l/min for 20 minutes (reaction time). The C₂H₄ flow is replaced by a N₂ flow of 2 l/min, the reactor is removed from the furnace and the N₂ flow is maintained for 10 min. After cooling to 25° C., the product is collected.

The catalyst weight loss (Tables 17-18) is measured by exposing 1 g of the supported catalyst preheated from 25 to 700° C. in 5 min, under 300 ml/min N₂ flow, followed by a 5 min plateau at 700° C. and cooling to 25° C., while maintaining the gas flow. The obtained material is called “cat. dry” hereafter.

The term carbon deposit (C dep. in Tables 17-18) stands for:

Carbon deposit(%)=100(m_{crude}−m_{cat. dry})/m_{cat. dry}

Where: m_{crude} is the mass of the as made carbon material and spent supported catalyst; m_{cat. dry} is the mass of spent supported catalyst. The carbon material is made of MWNTs, DWNTs, SWNTs, carbon fibers, amorphous carbon, carbon nanoparticles, pyrolytic carbon and soot in variable weight ratios. The higher the carbon nanotubes content (MWNTs+DWNTs+SWNTs), the better the quality of the carbon material. Among the CNTs, the helical nanotubes content is also estimated. The calculation of the helical nanotube percentage, for some samples, was performed using TEM pictures of low magnification and a total number of 300 single carbon nanotubes. The CNTs abundance (Ab. in Tables 17-18), length and diameter (Diam. in Tables 17-18) were also estimated from low magnification TEM pictures.

The hCNTs were split into 3 categories, depending on their coil diameter, as follows: h1<200 nm<h2<400 nm<h3<600 nm.

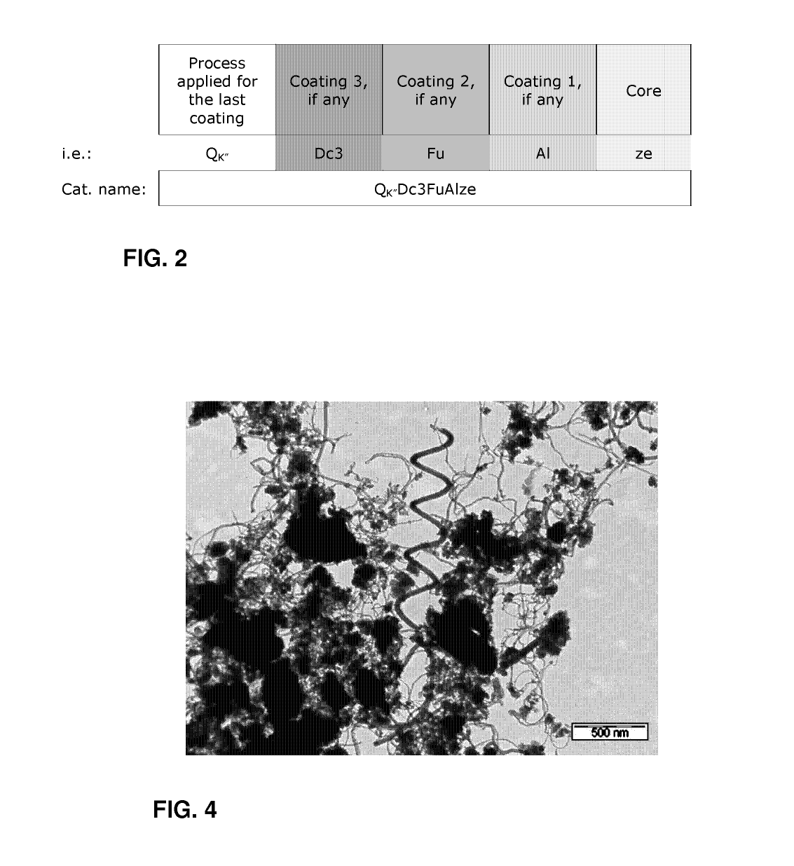

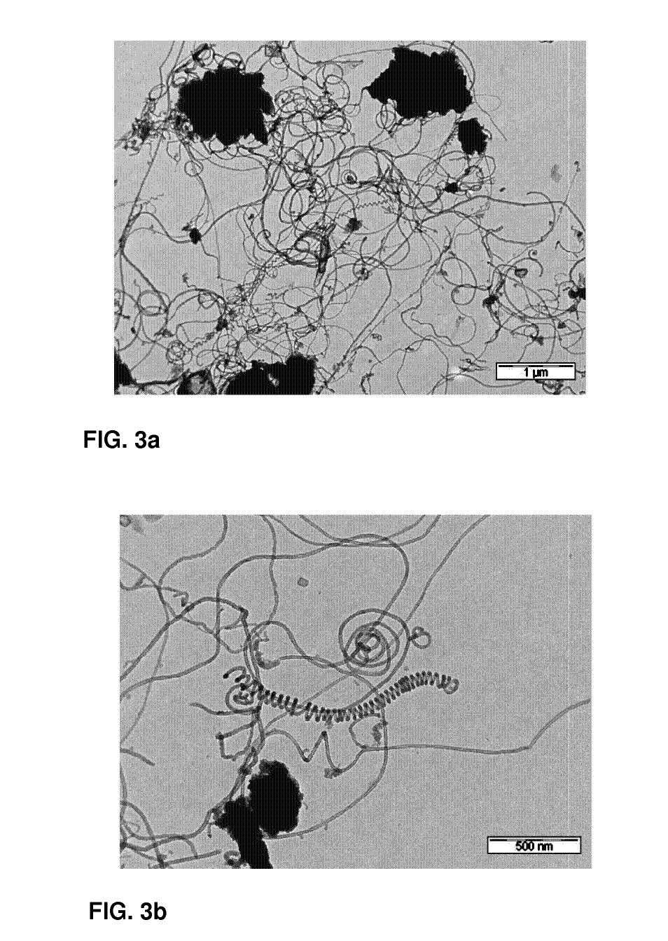

The hCNTs of the category h1, are characterized by helical shapes of long periodicities, while those of the categories h2 and h3 have helical shapes of short and very short periodicities, respectively. Hence, the hCNTs of categories h2 and h3 are mainly characterized by the curvature of the CNTs (FIG. 3). Nevertheless, when the nanotube diameter is very large, even the hCNTs of category h3 can have helical shapes of long periodicities (FIG. 4).

Some of the results of the catalytic tests are reported in Tables 17-18. In these Tables, the quality of the carbon material from TEM observations was attributed as follows: +++ very high density; ++ high density; + medium density; − low density; −− very low density; −−− not observed.

TABLE 17
Relative activity of some reference and multiphase
supported catalysts, to produce carbon nanotubes.

| Catalyst | | | | | Quality of the CNTs from TEM | | | | | |
|---|---|---|---|---|---|---|---|---|---|---|
| | | Loss | | C dep. | | Length | Dia. | h1 | h2 | h3 |
| Type* | Name | (%) | Test | (%) | Ab. | μm | (nm) | (%) | (%) | (%) |
| Ref. | A | 8 | A″ | 48 | ++ | 2 | 20 | − | + | ++ |
| Ref. | Ac | 24 | A″ | 47 | | | | | | |
| Ref. | B | 4 | A′ | 33 | | | | | | |
| Ref. | B | 4 | A″ | 17 | ++ | 10 | 20 | −−− | + | ++ |
| Ref. | Bc | 7 | A″ | 16 | | | | | | |
| Ref. | B1 | 4 | A′ | 21 | | | | | | |
| Ref. | B1c | 0 | A′ | 16 | | | | | | |
| Ref. | B2 | 20 | A′ | 30 | | | | | | |
| Ref. | B3 | 32 | B″ | 76 | | | | | | |
| Ref. | B4 | 20 | A^{IV} | 72 | | | | | | |
| Ref. | C1 | 16 | A′ | 45 | +++ | 10 | 15 | −− | + | ++ |
| Ref. | C1 | 16 | A″ | 57 | ++ | 3 | 20 | −− | + | ++ |
| Ref. | Cc1 | 28 | A″ | 55 | | | | | | |
| Ref. | C2 | 32 | A′ | 1531 | | | | | | |
| Ref. | C3 | 32 | A′ | 53 | | | | | | |
| Ref. | C4 | 20 | A′ | 170 | | | | | | |
| Ref. | C5 | 20 | A′ | 100 | | | | | | |
| Ref. | C6 | 20 | A′ | 40 | | | | | | |
| Ref. | C7 | 12 | A′ | 32 | +++ | 10 | 15 | −−− | + | ++ |
| Ref. | C8 | 12 | A′ | 977 | | | | | | |
| Ref. | C9 | 20 | A′ | 40 | | | | | | |
| Ref. | D1 | 32 | A″ | 61 | + | 2 | 20 | −− | + | ++ |
| Ref. | Dc1 | 16 | A″ | 48 | | | | | | |
| Ref. | D3 | 25 | A^{IV} | 33 | | | | | | |
| Ref. | D4 | 50 | A′ | 40 | | | | | | |
| Ref. | D5 | 12 | A′ | 23 | | | | | | |
| Ref. | D6 | 36 | A′ | 25 | | | | | | |
| Ref. | E5 | 28 | A′ | 28 | | | | | | |
| Ref. | E5 | 28 | A″ | 55 | | | | | | |
| Ref. | E6 | 8 | A″ | 71 | | | | | | |
| Ref. | E7 | 28 | A″ | 67 | ++ | 2 | 20 | −− | + | ++ |
| Mult. | F | 22 | A′ | 50 | | | | | | |

*Ref. and Mult. stand for reference and multiphase, respectively.

TABLE 18
Relative activity of some layered multiphase
supported catalysts, to produce carbon nanotubes.

| Catalyst | | | | | Quality of the CNTs from TEM | | | | | |
|---|---|---|---|---|---|---|---|---|---|---|
| | | Loss | | C dep. | | Length | Diam. | h1 | h2 | h3 |
| Type* | Name | (%) | Test | (%) | Ab. | μm | (nm) | (%) | (%) | (%) |
| 3 | GA | 8 | A″ | 20 | −−− | | | | | |
| 3 | GB | 10 | A″ | 18 | | | | | | |
| 3 | GB1 | 27 | B′ | 48 | | | | | | |
| 3 | GB3 | 6 | A′ | 19 | −− | 1 | 30 | −−− | −− | − |
| 3 | GC1 | 22 | A′ | 6.8 | | | | | | |
| 3 | GC1 | 22 | A″ | 20 | | | | | | |
| 3 | GC1 | 22 | A^{IV} | 20 | | | | | | |
| 3 | GC2 | 8 | A′ | 183 | | | | | | |
| 3 | GC9 | 26 | A′ | 40 | +++ | 8 | 20 | −− | − | ++ |
| 3 | GC10 | 24 | A^{IV} | 31 | + | 2 | 30 | −− | − | + |
| 3 | GD1 | 16 | A″ | 31 | | | | | | |
| 3 | GD1 | 16 | A^{IV} | 26 | | | | | | |
| 3 | GD5 | 20 | A′ | 37 | + | 2 | 15 | −− | − | + |
| 3 | GD6 | 18 | A′ | 10 | −−− | | | | | |
| 3 | GD6 | 18 | A^{IV} | 29 | | | | | | |
| 3 | GD7 | | | | + | 3 | 30 | − | + | ++ |
| 1 | HB1 | 26 | A′ | 27 | − | 5 | 30 | −− | − | + |
| 1 | HC10 | 34 | A′ | 6 | | | | | | |
| 1 | H″A | 25 | A^{IV} | 3 | | | | | | |
| 1 | H″B1 | 25 | A^{IV} | 12 | | | | | | |
| 1 | H″B4 | 45 | A^{IV} | 63 | | | | | | |
| 1 | H″C8 | 32 | A^{IV} | 70 | | | | | | |
| 1 | H″C11 | 35 | A^{IV} | 65 | | | | | | |
| 1 | H′″A | 30 | A^{IV} | 40 | | | | | | |
| 1 | H′″B | 47 | A^{IV} | 10 | | | | | | |
| 1 | I′B4 | 60 | A′ | 20 | +++ | 2 | 25 | 3 | 20 | 30 |
| 1 | I″A | 25 | A^{IV} | 52 | | | | | | |
| 1 | I″B | 60 | A′ | 40 | +++ | 3 | 25 | 8 | 20 | 30 |
| 1 | I″B1 | 16 | A′ | 4.8 | ++ | 1 | 20 | 2 | 5 | 15 |
| 1 | J′A | 56 | A′ | 73 | ++ | 2 | 15 | 8 | 20 | 30 |
| 1 | J′B | 60 | A′ | 180 | + | 1 | 10 | 0.5 | 5 | 10 |
| 1 | J′B1 | 36 | A′ | 50 | + | 1 | 20 | 1 | 5 | 15 |
| 1 | J′B4 | 40 | A′ | 67 | + | 1 | 20 | 0.5 | 5 | 15 |
| 2 | K′D1si | 12 | A′ | 163 | +++ | 2 | 18 | 1 | 10 | 20 |
| 2 | K′D5si | 24 | A′ | 5.3 | ++ | 2 | 25 | 2 | 15 | 25 |
| 2 | K′D6si | 32 | A′ | 6 | − | 1 | 20 | 0.2 | 5 | 10 |
| 2 | K′D8si | 12 | A′ | 4.5 | ++ | 3 | 20 | 1 | 10 | 20 |
| 4 | OD2Alal | 80 | A′ | 260 | ++ | 2 | 20 | 1 | 20 | 20 |
| 4 | OD3Alal | 68 | A′ | 150 | +++ | 3 | 13 | 12 | 25 | 35 |
| 4 | OD6Alal | 48 | A′ | 8 | −− | 1 | 20 | 0.1 | 1 | 2 |
| 4 | OD7Alal | 40 | A′ | 7 | ++ | 2 | 30 | 4 | 10 | 20 |

*According to FIG. 1.

No carbon deposit was observed, under the catalyst test A′, for the layered multiphase supported catalysts IAc, IBc, I′Ac, I′Bc, K′D3si, K″D3si, OD1Alsi, OD1Amsi, OD2Alsi, OD2Amsi, OD3Fusi.

3. Interpretation of the Carbon Nanotubes Production, on the Layered Multiphase Supported Catalysts, Results

As seen in Tables 17 and 18, hCNTs could be observed in most of the samples, presenting a carbon deposit and analyzed by TEM. Nevertheless, the abundance of hCNTs was different, depending on the catalyst and catalyst test. For most of the samples analyzed by TEM, the subdivision of the hCNTs into the categories h1, h2 and h3 was only qualitatively estimated (Table 17 and part of Table 18). Quantitative estimation of the hCNTs ratios was also achieved for some samples, depending on the quality of the TEM results (Table 18). Even though, mainly the hCNTs of the category h1 have a clear helical shape (see FIG. 3), those of categories h2 and h3, if made by CNTs of small diameter, are very flexible and do not show clear helicity for several pitches (see FIG. 4). Nevertheless, the hCNTs of categories h2 and h3 also contribute to the crumbled nature of the samples, making a material that is difficult to disentangle and, hence have the typical mechanical properties wanted for the helical nanotubes samples.

Hence, the fact that layered multiphase supported catalysts are made of multiphase particles containing catalyst nanoparticles in one or more layer(s) (i.e. in the core of the layers, in the outer layer(s), in the core and in the outer layer(s), in the intermediate layer(s)), affects the activity and selectivity of said catalysts for helical carbon nanotubes production. In particular, the layered multiphase supported catalysts, containing catalyst nanoparticles in the outer layer(s) can have higher activities, as a result of higher metal(s) loading of the particles outer layer(s). Moreover, decreasing the outer layer(s) thickness, at constant metal(s) loading can also increase the activity of said catalysts.

4. Miscellaneous

Most of the experiments were run applying silica as particle core because it is convenient for the preparation of very active and selective supported catalysts for helical CNTs synthesis. Nevertheless, experiments were also performed applying other particle cores such as zeolite, alumina, calcium carbonate, aluminum hydroxide, Mg₂Si₂O₆, magnesia and clays.

Optionally, the reaction of the metalorganic salt with the layered multiphase catalyst support, promoted by the heat during the activation step, can also be activated by any other radiation such as ultrasounds . . .

Optionally, plasma vapor deposition (PVD) can be used for one or several steps of the preparation of the layered multiphase catalyst (i.e. deposition of a carbon and/or inorganic layer, deposition of a metal(s) layer, deposition of the metal(s) nanoparticles . . . )

DWNTs and SWNTs were also obtained on the supported catalysts, applying catalyst Test D and Test E, respectively. Hence, layered multiphase supported catalysts for the synthesis of DWNTs and SWNTs are also part of the present invention.

### GENERAL CONCLUSIONS

Layered multiphase supported catalysts made of multiphase particles containing catalyst nanoparticles, are efficient catalysts for helical carbon nanotubes production. Other types of nanotubes (i.e. straight and coiled nanotubes as well as double wall and single wall nanotubes) can also be produced on these catalysts.

1. Layered multiphase supported catalyst made of multiphase particles containing catalyst nanoparticles, for carbon nanotubes production.

2. Layered multiphase supported catalyst according to claim 1 wherein the nanotubes are helical carbon nanotubes.

3. Layered multiphase supported catalyst made of multiphase particles according to claim 1 wherein the catalyst nanoparticles are located in one or more of the layers or in the core of the layer(s).

4. Layered multiphase supported catalyst according to claim 1 wherein the catalyst nanoparticles are located in the core of the layers(s).

5. Layered multiphase supported catalysts according to claim 1 wherein the catalyst particles are located in the core and in the outer or intermediate layer(s).

6. Carbon nanotubes produced on layered multiphase catalyst supports.

7. Carbon nanotubes produced on layered multiphase supported catalysts.

8. Helical carbon nanotubes produced on layered multiphase supported catalysts.

9. Single wall carbon nanotubes produced on layered multiphase supported catalysts.

10. Double wall carbon nanotubes produced on layered multiphase supported catalysts.

11. Multi wall carbon nanotubes produced on layered multiphase supported catalysts.

12. Carbon fibres produced on layered multiphase supported catalysts.

13. Crude carbon nanotubes containing 1 to 99% and preferably 10 to 90% of spent layered multiphase supported catalyst.

14. Layered multiphase supported catalyst pellets obtained by pressing, preferably at a pressure of 1-3 ton/cm², a layered multiphase supported catalyst as provided in claim 1, and uses thereof.

15. Layered multiphase supported catalyst made of multiphase particles according to claim 2 wherein the catalyst nanoparticles are located in one or more of the layers or in the core of the layer(s).

16. Layered multiphase supported catalyst according to claim 2 wherein the catalyst nanoparticles are located in the core of the layers(s).

17. Layered multiphase supported catalysts according to claim 2 wherein the catalyst particles are located in the core and in the outer or intermediate layer(s).
